(19) United States
(12) Patent Application Publication
(10) Pub. No.: US 2011/0035272 A1
(43) Pub. Date: Feb. 10, 2011

(54) FEATURE-VALUE RECOMMENDATIONS FOR ADVERTISEMENT CAMPAIGN PERFORMANCE IMPROVEMENT

(75) Inventors: Rushi P. Bhatt, Bangalore (IN); Vijay Krishna Narayanan, Mountain View, CA (US); Rajesh Parekh, San Jose, CA (US); Xia Wan, Saratoga, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/536,113

(22) Filed: Aug. 5, 2009

(51) Int. Cl. G06Q 30/00; G06Q 10/00

(52) U.S. Cl. 705/14.42; 705/14.43; 705/14.46

(57) ABSTRACT

A method for making recommendations to improve advertisement campaign performance includes receiving a seed campaign insertion order (IO) having one or more campaign IO lines; computing a plurality of neighbor ad campaigns based on a comparison of the seed campaign IO with a dataset of advertiser ad campaign IO lines; generating campaign IO recommendations by executing an algorithm to recommend a campaign feature and value (FV) as a change to a line of the seed campaign IO based on success of such use by the neighbor ad campaigns; ranking the FV recommendations based on at least one performance metric; filtering the FV recommendations based on a plurality of performance-enhancing criteria of the seed campaign IO and the neighbor ad campaigns with respect to individual FV recommendations; and displaying the ranked FV recommendations to the advertiser for selection.

### BACKGROUND

1. Technical Field

The disclosed embodiments relate to the making of recommendations to advertisers regarding improving their advertisement (ad) campaigns, and more particularly, to providing a recommendation engine or processor to automate the generation, filtration, and ranking of feature/value (FV) pair recommendations usable to change lines of a seed campaign insertion order (IO) and of full profile recommendations that suggest addition of new IO lines.

2. Related Art

When a user visits a Web page of a Web content provider (i.e., online publisher), the Web page often displays one or more advertisements together with its contents. An advertisement that is displayed via the Internet is often referred to as a display or banner advertisement. A display advertisement typically includes a link to a website of the advertiser. When a user clicks on a link in the display advertisement, the user may be redirected to the website advertised therein, referred to as a landing page. A display or banner advertisement may be placed at a variety of locations of a Web page including at the top (i.e., the North), the right hand side (i.e., the East), and the bottom (i.e., the South) of the Web page.

In order to execute an advertisement campaign, advertisers typically pay online publishers to place their advertisements on one or more Web pages. In the widely used cost-per-click (CPC) model, each advertiser is typically charged by an advertising brokerage such as Yahoo! from Sunnyvale, Calif. only when her ad receives a click. In another popular pricing model, an advertiser is charged based upon the number of impressions that are guaranteed, such as a cost per thousands of impressions (CPM). Impressions only require that Web users see the advertisements. In contrast, some models may charge a cost per acquisition (CPA), which requires the Web user to not only click to the landing page, but also actually take action on the landing page such as filling out a questionnaire or making a purchase. Whatever model is used, it is in the best interest of such advertising brokerages to help advertisers be successful by helping them increase performance metrics such as click-through rates (CTR), which often leads to a higher return on investment (ROI).

Advertisers generally request that a minimum number of impressions (i.e., views) be guaranteed. In addition, advertisers may also specify additional conditions that are to be satisfied by the online publisher of the ads. For example, the advertisers may specify a desired target profile of users who are to receive a particular advertisement. As another example, advertisers may also specify a particular position in which an advertisement is to be placed. These advertising features or requirements, referred to generally as booking information, are integrated into campaign insertion order (IO) lines used by computers at Yahoo! to deliver advertisements to the correct publisher Web page and location at the right time, having the correct dimensions, etc. A publisher will typically attempt to maximize their own profits, e.g., by achieving high CTRs, while satisfying the requirements of the advertisers. There are many choices available to advertisers when placing their advertisements with an online publisher (see FIG. 3). Unfortunately, evaluating advertisement campaigns can be a time-consuming and cumbersome process.

Large advertisers with Yahoo! typically enjoy the benefits of interacting with a dedicated account manager who helps the advertiser set up appropriate ad campaigns while considering their performance goals and further assisting them in monitoring and fine-tuning the campaign as it progresses. Such on-going participation in ad campaign tuning is required for successful ad campaigns because the advertising market-including advertisers and online users-is fluid and changing. Changes to ad campaigns preferably consider a large amount of data available in the related advertising market, including the activity of other advertisers and potential targeting attributes of the online users (or browsers).

The account managers bring their rich domain knowledge and vast experience to bear on making campaign recommendations to their client advertisers. This approach, however, is clearly not viable when an advertising network like that of Yahoo!'s deals with tens of thousands of advertisers. What is needed, therefore, is a campaign optimization system that generates recommended changes to campaign insertion order (IO) lines of an advertiser in a way that is scalable, automated, and data-driven so as to consider the successful features of campaigns of other advertisers in the same or “neighbor” field.

### BRIEF DESCRIPTION OF THE DRAWINGS

The system and method may be better understood with reference to the following drawings and description. Non-limiting and non-exhaustive embodiments are described with reference to the following drawings. The components in the drawings are not necessarily to scale, emphasis instead being placed upon illustrating the principles of the present disclosure. In the drawings, like referenced numerals designate corresponding parts throughout the different views.

FIG. 1 is a block diagram of an automated, campaign performance improvement recommendation system according to the present disclosure.

FIG. 2 is a diagram illustrating example user data that may be obtained or collected in accordance with various embodiments of the system of FIG. 1.

FIG. 3 is a diagram illustrating an example ad campaign such as an advertiser seeks to optimize or on which to improve through the system of FIG. 1.

FIG. 4 is a block diagram of the system of FIG. 1, showing additional detail with relation to the recommendation server and the advertising server.

FIG. 5 is a block diagram of a detailed representation of the architecture and functionalities of the recommendation engine displayed in FIGS. 1 and 4.

FIG. 6 is a flow diagram of a method for identifying neighbor ad campaigns for Internet advertisement targeting.

FIG. 7 is a flow diagram of a method for processing ad campaign information as shown at block 604 of FIG. 6.

FIG. 8 is a flow diagram of a method for generating feature/value (FV) insertion order (IO) recommendations for an ad campaign.

FIG. 9 is a flow diagram of a method for calculating a score for each of a plurality of candidate FV pairs of FIG. 8, and ranking the scores in decreasing order of score.

FIG. 10 is a flow diagram of a method for generating profile recommendations for an ad campaign.

FIG. 11 is a flow diagram of a method for analyzing neighbor ad campaigns with performance criteria, to qualify potential profile recommendations from FIG. 10 for referral to an advertiser.

FIG. 12 is a flow diagram of a method for generating profile recommendations by affinity-based analysis of the profiles of an ad campaign and neighbor ad campaigns.

FIG. 13 is a flow diagram of a method for filtering recommendations generated using an affinity method before referral to an advertiser.

### DETAILED DESCRIPTION

By way of introduction, included below is a system and methods for optimizing advertisement (ad) campaigns of advertisers through automating the generation, filtration, and ranking of feature/value pair recommendations usable to change lines of a seed campaign insertion order (IO) and of full profile recommendations that suggest removal or addition of IO lines. A recommendation server may be employed within the system to execute the methods disclosed herein.

An advertising product available for purchase from an online publisher may be defined by a variety of attributes (i.e., booking information). For example, booking information may specify the Web page and/or position within a Web page where the ad is going to appear. The booking information may also include or identify text, image(s), audio, and/or video content of the advertisement. An ad product may be identified or defined by booking information such as a business category, campaign name, tag(s), and/or keyword(s) associated with the advertisement. A product may be further defined by a target user profile. The target user profile may indicate geographic, demographic, and/or behavioral attributes of desired viewers of an advertisement. The days and/or time of the day the ad is to appear may also be regarded as part of the target profile. The booking information may also include the number of impressions to be provided in association with the target profile, maximum daily budget of the advertiser and/or total budget of the advertiser. Each piece of booking information can be regarded as assigning a value to a feature of an advertisement product.

A product may be identified by booking information such as that described above. Product booking information associated with a set of products used by an ad campaign may be referred to as campaign booking information or data. Similarly, all campaign booking information of an advertiser may be referred to as advertiser information or data, and be cast into lines of an insertion order (IO) for each campaign.

An online publisher may wish to recommend various features or products to an advertiser. In order to ascertain one or more products (or features) to recommend to the advertiser, it may be desirable to identify neighbor (or similar) ad campaigns. Through analyzing results of executing neighbor campaigns, the online publisher may recommend products (or features) based on the experience of other neighbor ad campaigns.

Accordingly, the recommendation server receives a seed campaign IO, which includes one or more campaign IO lines, from an advertiser that wishes to improve performance thereof. After reception of the seed campaign IO, the server may determine a plurality of neighbor (or similar) advertisement (ad) campaigns based on a comparison of the seed campaign IO with a dataset of advertiser ad campaigns IO lines by (i) processing campaign booking and performance information associated with ad campaigns previously booked by a publisher, and (ii) applying thereto a statistical document clustering technique such as probabilistic latent semantic indexing (PLSI). For additional disclosure related to these steps, a related application, U.S. patent application Ser. No. 12/419,923, titled FINDING SIMILAR CAMPAIGNS FOR INTERNET ADVERTISING TARGETING, was filed on Apr. 7, 2009. This application is also related to U.S. patent application Ser. No. ______, titled PROFILE RECOMMENDATIONS FOR ADVERTISEMENT CAMPAIGN PERFORMANCE IMPROVEMENT, filed on ______ (Attorney Docket No. 12729-623). These applications are hereby incorporated by reference.

To improve the seed campaign IO, the recommendation server may then generate campaign IO recommendations by executing an algorithm to recommend a campaign feature and value (FV) pair as a change to a line of the seed campaign IO based on success of such use by the neighbor ad campaigns. Use of the FV in the neighbor IOs (or campaigns) is considered successful if the lines of the neighbor IO with the FV present have a CTR that is at least as high as or above the average CTR of the corresponding neighbor IOs. Note that another performance metric may be used instead of CTR. The server, additionally or alternatively, may generate IO recommendations by executing a second algorithm to recommend profiles to add to the seed campaign IO, which are derived from booking lines corresponding to the profiles based on performance of such use by the neighbor ad campaigns being generally above average when compared with campaigns that did not use the recommended profiles. The recommendation server may then filter the FV and profile recommendations based on a plurality of performance-enhancing criteria of the one or more campaign IO of the advertiser. The server may then rank (or order) the FV and profile recommendations—either together or separately—based on at least one performance metric, and display the ranked FV recommendations and the ranked profile recommendations to the advertiser for selection. To help the advertiser decide on whether to use an FV and/or profile recommendation, each may be incorporated into the ad campaign of the advertiser as a simulation, to predict a value of a performance metric based on the adoption thereof.

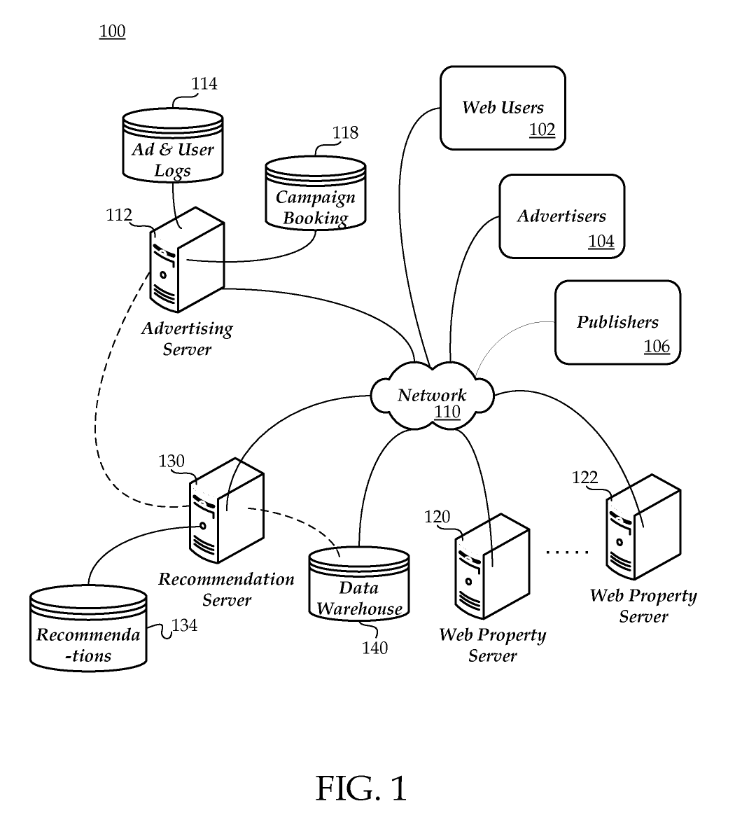

FIG. 1 is a block diagram of an automated, campaign performance improvement recommendation system 100 in which various embodiments of the present disclosure may be implemented. The system 100 may include, but is not limited to, a plurality of Web users 102, advertisers 104, and publishers 106, all referenced above and that will be discussed in more detail below. The Web users 102, advertisers 104, and publishers 106 may communicate over a network 110 such as the Internet, the Web, a local area network (LAN), a wide area network (WAN), or other network, to interact with the rest of the system 100. The system 100 thus may further include an advertising (ad) server 112 that is coupled with an ad and user logs database 114 and a campaign booking database 118. Herein, the phrase “coupled with” is defined to mean directly connected to or indirectly connected through one or more intermediate components. Such intermediate components may include both hardware and software based components, including the network 110. The campaign booking database 118 may also include calculated performance data (CTR, CPC, etc.).

The system 100 may further include one or more Web property servers 120, 122, also referred to herein as “Web servers,” and a recommendation server 130 coupled with a recommendations database 134 for storing recommendations and coupled with a data warehouse 140. The data warehouse 140 is coupled with the network 110 and may be accessed over the network because it may be located in disparate locations across the United States, or in other countries. The data warehouse 140 may receive and store campaign IOs in relation to specific advertisers and be tracked according to dates and times those campaign IOs were active. Accordingly, ad campaign booking information may be obtained from the ad server 112 and stored in the data warehouse. Similarly, click and user-action data related to display and banner advertisements may be obtained from the ad server 112 and stored in the data warehouse.

The dashed lines indicate that the advertising server 112 may be directly coupled with the recommendation server 130, which may be directly coupled with the data warehouse 140. Indeed, the advertising and recommendation servers 112, 130 may be combined into a single server, but is disclosed as separate entities herein for clarity. The recommendation server 130 may have local access to its own copy of the data warehouse 140 to help speed up periodic (often daily or more frequent) execution of the recommendation algorithms disclosed below. If that were the case, then the local copy of the data warehouse could be updated continuously over the network, e.g., over the Internet, and purged of old data as often as needed or as thought advisable for the best recommendations.

A plurality of Web users 102 may receive impressions (or views) of one or more advertisements upon accessing a Web page via one of the Web property servers 120, 122. Each Web property server delivers Web pages related to one or more Yahoo! properties such as Games, Autos, Finance, Music, Shopping, and HotJobs® to name just a few. Web pages accessed through browsing the Yahoo! pages are served (delivered) by the Web property servers. These Web pages may also be accessible through Yahoo! search, e.g., by choosing a search result returned in response to a search query. Accordingly, this disclosure is intended to be interpreted broadly to include any publisher Web page that is accessible by Web users within the system 100, no matter how that publisher Web page becomes the landing page of an advertisement. For instance, advertisements may be transmitted by an ad server (not shown) maintained by an advertiser, e.g., in the form of pop up windows. Alternatively, an ad may be transmitted to the Web users 102 via electronic mail, wherein the Web user may select an advertising link and be directed to the advertiser website. The Web users or browsers may be coupled to the Web servers 120, 122 via the network 110. The network 110 may include any suitable number and type of devices, e.g., routers and switches, for forwarding search or Web object requests from each Web user to the search or Web application and for returning search or Web results back to the requesting users.

As will be described in further detail below, an ad campaign may have one or more corresponding advertisements associated therewith that are delivered to users via one or more products available from the online publisher 106. When a user visits a Web page, the system 100 (e.g., the ad server 112) may identify the best Web advertisement to place in the Web page. Information indicating whether the user clicks on the advertisement and/or purchases a product or service as a result of clicking on the advertisement may also be maintained and stored in the ad and user logs database 114. The user click and action information, which includes purchases, newsletter hits, etc., enable computation of a click-through rate and/or cost of conversion for the advertisement. By tracking the historical performance of an ad campaign, it is possible to ascertain the effectiveness of the ad campaign and/or product(s) or IO lines used in the ad campaign.

The recommendation server 130 may implement embodiments disclosed herein for ascertaining the effectiveness of a campaign, identifying similar (or neighbor) campaigns, and/or recommending advertising products used in neighbor campaigns. Recommendations generated by the server 130 may be stored in the recommendations database 134. The recommendation server 130 may access ad campaign information for ad campaigns that have previously been booked by online publishers. The ad campaign information for various ad campaigns may be stored in the campaign booking database 118, which as discussed above, may be replicated and archived in the data warehouse 140. In order to ensure that the ad campaign information remains pertinent, the oldest campaign information may be purged periodically. For instance, it may be desirable to retain ad campaign information for a period of several months or years.

When a feature/value (FV) or profile ad recommendation is made, it may be displayed to an advertiser 104 through an interface made available to the advertiser through the ad server 112. The advertiser may select certain profiles and ask the system 100 to predict a lift or increase in performance (e.g., in CTR) due to adoption of one or more of the recommendations. The advertiser may then formally select and adopt one or more of the recommendations as part of at least one campaign IO. Enabling interface through the ad server 112 may keep it more familiar to the advertisers and provide for seamless integration with previously-established advertiser campaign booking interfaces.

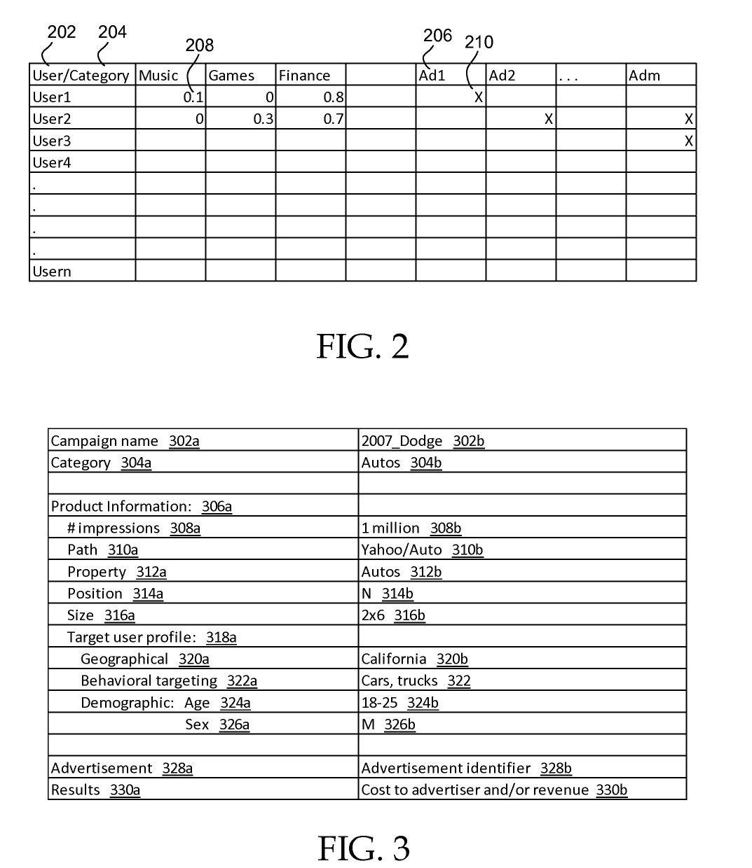

An ad server 112 of the online publisher may have access to one or more user logs (e.g., user databases) in which user information is retained, and which may be stored in the ad and user logs database 114 within one or more memories or storage mediums coupled with the ad server 112. Each time a user performs online activities such as clicking on an advertisement or purchasing goods or services, information regarding such activity or activities may be retained as user data in the user logs 114. For instance, the user data that is retained in the user logs may indicate the identity of Web sites visited, identity of ads that have been selected (e.g., clicked on) and/or a timestamp. User data representing the activities of the users 102 may be retained or summarized in the user logs as scores. Additional user data such as demographic information (e.g., age and/or gender) and/or geographic information (e.g., zip code) may also be retained in the user logs. A user may be identified in the user logs by a user ID (e.g., user account ID), information in a user cookie, etc. Example user data that may be stored in the user logs database 114 will be described in further detail below with reference to FIG. 2. Where the online publisher supports a search engine (not shown), e.g., via the ad server 112 or a separate search server, information associated with a search query may also be retained in the user logs 110. Information associated with a search query may include search term(s) of the search query, information indicating characteristics of search results that have been selected by the user, and/or associated timestamps, etc.

An advertisement may include content which may be delivered via the Internet. The content typically includes text. However, note that an advertisement may include text, one or more images, video, and/or audio. An advertisement may also include one or more hypertext links, enabling a user to proceed with the purchase of a particular product or service.

The disclosed embodiments may also support the dynamic selection of advertisements to be provided to users. For instance, selected advertisement(s) may be provided to a user via the Internet. In one embodiment, when a user visits a Web page, the system may automatically select one or more advertisement(s) to be served to the user. The publisher may then automatically provide the selected advertisement(s) to the user.

In order to select advertisement(s) to be provided to a user, the system 100 may maintain user data for a plurality of users. The user data may indicate prior behavior of the plurality of users. The prior behavior of each of the plurality of users may be monitored with respect to a plurality of categories. For instance, each of the plurality of categories may identify a type of Internet content contained in Web sites or Web pages that may be visited by a user. In addition, the system 100 may monitor and track those ads that are clicked on by each user. The system may also monitor and track purchases that are completed once an ad has been clicked on by the user, when possible.

FIG. 2 is a diagram illustrating example user data that may be obtained or collected in accordance with various embodiments of the system of FIG. 1. In this example, the user data indicates for each of a plurality of users 202, prior behavior with respect to a plurality of categories 204 and a subset of a plurality of ads 206 previously clicked on (e.g., during a particular period of time). In this example, the categories 204 include Music, Games, and Finance. Note, however, that these categories 204 are merely illustrative, and therefore, these particular categories may or may not exist in the user logs. The user data indicating prior behavior of the users 202 may be ascertained from the user logs, as well as other sources of user data (e.g., user account information, cookie, purchase history, etc.).

For each of the users 202, a score 208 representing the prior behavior of the user may be stored in association with each of the categories 204. The score 208 may indicate a level of interest of the user 202 in the corresponding category 204 based upon prior Internet activity of the user 202. Thus, the score 208 may indicate the likelihood that the user 202 will click on an ad containing content that falls within that particular category 204. The Internet activity may include those Web sites or Web pages visited or clicked on by the user. Other parameters may be factored into the user score, including: the amount of time spent by the user on the Web sites or Web pages, the frequency and/or recency of the user visits, and/or other parameters of the visit. The online commercial activities of the user (e.g., in association with various categories 204) can be particularly interesting and factored into the score 208 with a higher weight. These commercial activities may include clicking on advertisements, filling out a purchase leading form (e.g., in association with a particular advertisement) and/or purchasing goods or services (e.g., via a particular Web site or in association with a particular advertisement). Data obtained from a search engine may also be incorporated into the user's score 208. Each score 208 may be a numerical value. In this example, the scores 208 are values between 0 and 1. However, the scores 208 may be represented using other value ranges.

The user data may also indicate a subset of the advertisements 206 that have been clicked on by the user 202 (e.g., during a particular period of time). In this example, an “X” indicates that the user 202 clicked on the corresponding advertisement 206, as shown at 210. Specifically, as shown in this example, User1 has clicked on Ad1, User2 has clicked on Ad2 and Adm, and User3 has clicked on Adm.

Although not shown in this example, the user data associated with each of the plurality of users may indicate a geographical location, age, and/or sex of at least some of the plurality of users. The user data may also indicate a purchase history of at least some of the plurality of users.

In this example, the user data is represented by a table. Note, however, that the user data may be stored in a variety of formats. The user data may be collected over a period of time (e.g., days, weeks, or months). Since the user data may become outdated, the system may purge the oldest user data. For instance, the system may maintain the user data for a period of several days, weeks, or months. The system may also implement a time decay function to weight an older event less than a fresh event. Given historical user data, finding an optimal delivery plan is possible. Specifically, one can maximize the probability of a user clicking on an advertisement based upon previously-collected user data. For a popular Web page, the statistics of categories of daily visitors can be quite stable. In other words, tomorrow's visitors are generally statistically quite similar to today's visitors. Therefore, today's optimal solution can be used as a base to deliver tomorrow's advertisements. Accordingly, once the user data has been collected, the system may generate a statistical model from the user data.

For a popular ad space, the number of page viewers, and therefore the number of impressions, on a given day can be very large. In this case, we can partition the historical data by time of the day, such as morning, afternoon, and/or evening. In other words, user data that is collected may be categorized and partitioned accordingly. Not only does this make the problem size much more manageable, but the factor of time of day may be built into the campaign analysis.

FIG. 3 is a diagram illustrating an example ad campaign line such as an advertiser seeks to optimize or on which to improve through the system of FIG. 1. An exemplary ad campaign may include additional lines, which may be added as additional products under product information 306a, such as under product information 306b (not shown), which will be discussed below. Each ad campaign may be defined by corresponding ad campaign information. As shown in this example, the ad campaign information associated with a campaign may be represented by a data structure such as a table. Campaign information, however, may be stored in a variety of formats.

The information for an ad campaign may indicate the subject matter of the ad campaign. For instance, the ad campaign information may include a name 302a of the ad campaign. In this example, the name of the ad campaign 302b is 2007_Dodge. The ad campaign information may also include a category 304a of the ad campaign (and corresponding advertisement(s)). For instance, the category 304a may indicate one or more of the categories used to categorize user behavior, as described above with reference to FIG. 2. In this example, the category is Autos.

An advertiser typically requires the online publisher to guarantee a minimum number of impressions. Thus, the ad campaign information may indicate the guaranteed number of impressions 308a. In this example, the number of impressions is 1 million, as shown at 308b. The ad campaign line information may also identify the product(s) sold by the online publisher 106 to the advertiser in order to publish the advertisement(s) for this ad campaign. In general, booking information associated with an advertising product may identify the “advertising space” being sold, as well as the target profile of users who would be viewing the “advertising space.”

The product(s) may each be identified by corresponding product information 306a, which may also be referred to as campaign booking information. Each product is a line within the campaign IO of the advertiser. The product information 306a may identify a path 310a on the Internet through which an advertisement for the ad campaign is to be published. In this example, the path 310a is a uniform resource locator (URL) for Yahoo/Auto 310b. The product information 306a may also identify a property 312a. In this example, the property 312a is a URL property, Autos 312b, which identifies a URL (e.g., landing Web page) to which the advertisement is to be published. The product information 306a may also indicate one or more position(s) 314a (e.g., within the Web page) via which the advertisement is to be published. Positions are often referred to in terms of North, South, East, and West. In this example, the position 314b is North (N). The product information 306a may also indicate a size 316a of the advertisement to be published. In this example, the size 316b is 2×6 inches.

The product information 306a may also identify a target user profile 318a of the desired users who are to receive the advertisement(s) for the corresponding campaign. For instance, the target user profile 318a may indicate geographic (geo) attribute(s) 320a, behavioral targeting attribute(s) 322a, and/or demographics (demo) such as age 324a or sex 326a. In this example, the geographic attribute(s) 320b indicate that the desired target audience is in California, the behavioral targeting attribute(s) 322b indicate that the desired target audience is interested in cars and/or trucks, and possibly visits sites on the Internet that are related to cars and/or trucks. The desired target audience is also between 18-25 years old and male (M), as shown at 324b and 326b, respectively.

The ad campaign may have one or more associated advertisements to be delivered via the product(s) identified in the ad campaign information. Thus, the ad campaign information may also identify an advertisement 328a to be published for this ad campaign. For instance, the advertisement 328a may be identified at 328b via a file name or other identifier. Moreover, the ad campaign information may also indicate the content (e.g., text) in the advertisement 328b, enabling this content to be used in the campaign analysis.

The ad campaign information may also indicate the results 330a of publishing the ad(s) associated with the campaign. The results 330b may be represented in a variety of ways. Moreover, the results 330b may include a variety of numerical values indicating how well the ad campaign performed for the corresponding advertiser. For instance, the results 330b may indicate the revenue of the ad campaign, total cost of the ad campaign, the CTR of the advertisement, the CPC for the advertiser, the cost per conversion to a sale, or another performance metric. The cost per conversion may be obtained by tracking orders submitted by users who click on the advertisement.

At least a portion of the ad campaign information may be stored for each ad campaign when the ad campaign is booked by the online publisher. The ad campaign information may also be updated periodically or upon satisfying the requirements of the advertiser for the ad campaign. For instance, the ad campaign information may be updated to indicate the results 330b of the ad campaign. Thus, in one embodiment, the system analyzes the ad campaign information for campaigns after the ad campaigns are completed (e.g., after the ad(s) have been published via the product(s) identified in the ad campaign information and the requirements of the advertisers for the campaigns have been satisfied).

When the recommendation server 130 generates a feature/value (FV) recommendation for consideration by an advertiser, it will take the form of a Feature=Value set of data such as those displayed in FIG. 3. For instance, the FV recommendation may be Behavior Targeting (BT) Shopper (322a)=Finance/Loans/Mortgage or the FV recommendation may be Property-Position (312a, 314a)=Autos/OEM. Furthermore, the FV recommendation may be Geo (320a)=True and/or Gender (326a)=Female.

When the recommendation server 130 generates a profile recommendation for consideration by the advertiser, it will take the form of an entire product line that includes fully specified placement attributes and user targeting attributes such as <Property, Position, BT, Geo, Demo>. The following are examples of potential values associated with a profile recommendation: (1) property/position=Finance/North; (2) BT Shopper=Automotive/Luxury/Sedan; (3) Geo Targeting=On; and (4) Gender=Male, Age=Young+Middle Age.

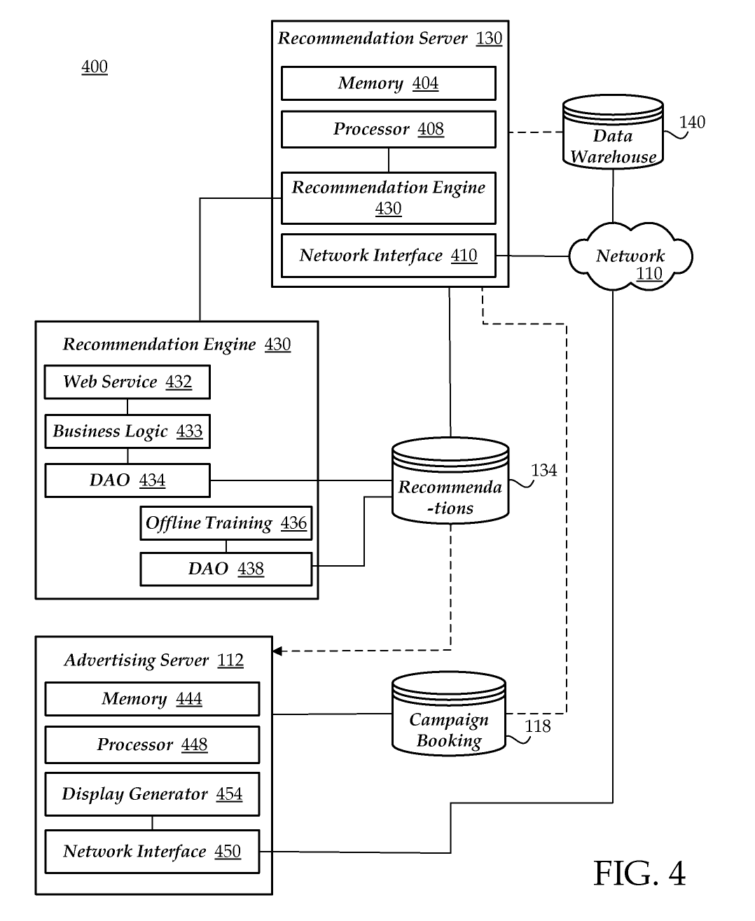

FIG. 4 is a block diagram 400 of the system 100 of FIG. 1, showing additional detail with relation to the recommendation server 130 and the advertising server 112. The recommendation server 130 includes a memory 404 and a processor 408. The processor 408 may contain a recommendation engine 430, or the recommendation engine 430 may be otherwise coupled with the processor 408. The recommendation server 130 may also include a network interface 410 for communication over the network 110. The recommendation server 130, as discussed, is coupled with the data warehouse 140.

The recommendation engine 430 may include a Web service 432, business logic 433, and a data access object 434 coupled with the business logic 433. The recommendation engine also includes an offline training module 436 coupled with another data access object 438. The data access objects 434, 438 may each be coupled directly with the recommendations database 134 to store and access ad campaign recommendations. The advertising server 112 may include a memory 444, a processor 448, a network interface 450 coupled with the network 110, and a display generator 454 to generate the display interface to the Web users 102 so that the Web users 102 may test and select FV and/or profile recommendations for incorporation into their ad campaigns. The dashed lines in FIG. 4 include alternative coupling of components to communication over the network 100 or Web.

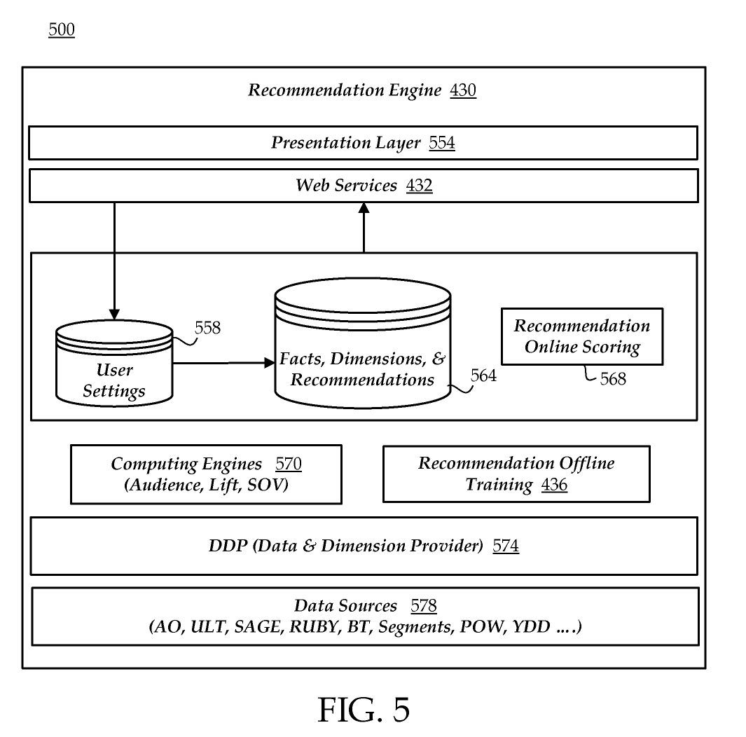

The Web service 432 is the interface between the recommendation engine 430 and a presentation layer (554 in FIG. 5). The business logic 433 provides the analytics code used by the recommendation engine to analyze the campaign booking information and user logs discussed above to compute performance information for advertiser campaigns and to execute the methods disclosed herein, which output FV and profile recommendations for the consideration of advertisers. When the recommendations are complete, the data access object 434 passes them to the recommendations database 134 for storage therein. The recommendations are stored in relation to the advertiser campaign IOs, and are made available to the advertising server 112 in order to present them in a display to each advertiser in a browser of each respective advertiser.

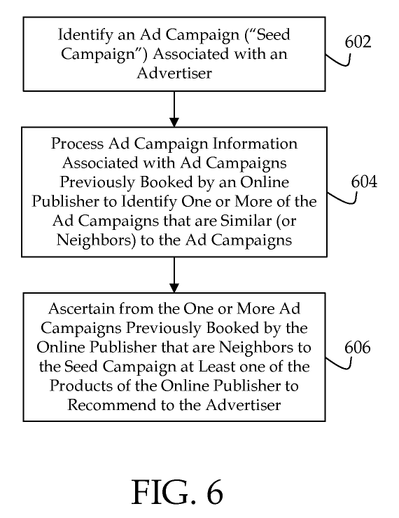

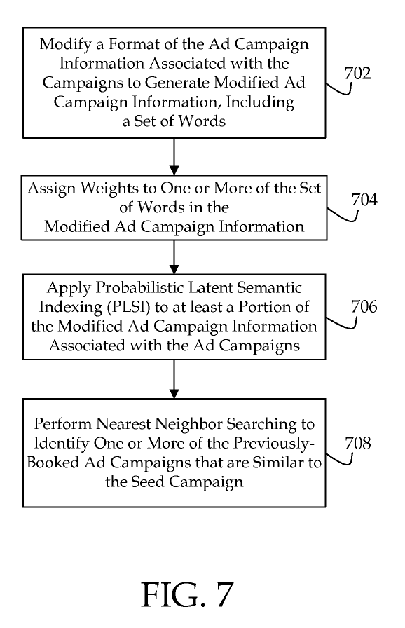

The offline training module 436 is run periodically to keep the business logic 433 updated with the algorithmic steps and data source considerations to make the recommendations made by the recommendation engine 430 as accurate as possible. For instance, the offline training module 436 may use two or so years of campaign booking and performance information, which includes up to about 300,000 IO lines, to train the recommendation engine 430. The offline training module 436 may be run by two different machines, one on a CTR basis and the other on a CPC—or other performance metric—basis. A simplified summary of at least some of the training steps performed by the offline training module 436 includes: performing PLSI—or another statistical document clustering technique—on the approximate two years of campaign booking information (discussed in more detail with relation to FIGS. 6-7 below) to find ad campaigns most similar to a seed campaign IO of an arbitrary advertiser; searching for nearest neighbors (NN) of the similar ad campaigns; and recommending full-line profiles using both performance-based ranking and an affinity model and recommending one-dimensional FV pairs. The algorithmic steps used currently to perform these recommendations will be disclosed in more detail below. The training recommendations may also be stored in the recommendations database 134 for use by the business logic 430 and/or recommendation engine 430 in executing recommendations for actual advertisers 104.

FIG. 5 is a block diagram of a detailed representation of the architecture 500 and functionalities of the recommendation engine 430 displayed in FIGS. 1 and 4. The recommendation engine includes a presentation layer 554, which is a graphical user interface (GUI) through which users can access the recommendations generated by the recommendation engine 430. As discussed, the Web services 432 include the interface between the recommendation engine 430 and presentation layer 554. The Web services 432 are Web service-based and serve the purpose of data exchange between the Web and the core of the recommendation engine 430.

The recommendation engine 430 further includes a user settings database 558, a facts, dimensions, and recommendations database 564, a recommendation online scoring module 568, a number of computing engines 570, a data and dimension provider (DDP) 574, and a set of data sources 578. A fact table is a database that describes a central entity, such as an advertiser or campaign. The various attributes of the entity are called dimensions. The details of various attributes of each entity may be captured in dimension tables. For instance, a campaign IO table having one or more lines (FIG. 3) is an example of a fact table. Campaigns include attributes such as advertiser, booking country, etc., which can be captured in dimension tables like an ADVERTISER table. Similarly, each line includes attributes such as user targeting, which can be captured in a TARGETING_PROFILES table.

The user setting database 558 is created and accessed by the presentation layer 554 to record and store user preferences, which may be obtained from the user logs. The facts, dimensions, and recommendations database 564 may be an extension of the recommendations database 134 in including analytics reports in relation to the relevant recommendations. The recommendation online scoring module 568 is an online scoring module for executing recommendations of campaign seed IOs. The recommendation online scoring module 568 accesses the recommendations database 134 and/or 564 to fetch pre-calculated recommendations, and to execute, in real time, custom recommendations requested by advertisers. The recommendation online scoring module 568 also gets price and inventory information for the recommended products. The recommendation offline training module 436 was discussed with reference to FIG. 4.

The computing engines 570 produce analytics reports such as for: (1) audience segmentation, which is the demographic, geographic, and behavioral statistics of the users who are exposed to the campaigns of the advertisers; (2) lift, which is the CTR improvement when advertisers book both display and search campaigns; and (3) share of voice (SOV), or the percentage of the product bought by a specific advertiser compared to other advertisers. Note that the computing engines 570 need not necessarily be a part of the recommendation engine 430, as they may be executed by the processor 408 or other engine, but is displayed as such for simplicity of discussion.

The data and dimension providers (DDP) 574 is an information gateway into the analytics aspects of the recommendation engine 430 such as the recommendation online scoring 568 and business logic 433 modules. The DDP is responsible for, among other things: (1) bringing in data (facts and dimensions) from all external sources, e.g., the data sources 578; (2) filtering and transforming this data as required by the recommendation engine 430; (3) loading dimensions into the recommendation engine 430; (4) computing benchmark definitions; (5) providing mapping files for the computing engines 570 that do not understand the semantics of the data; and (6) massaging the fact data as required by the recommendation engine 430.

FIG. 6 is a flow diagram of an exemplary method for identifying neighbor ad campaigns for Internet advertisement targeting. The system 100 may identify an ad campaign associated with an advertiser, at block 602, which will also be referred to herein as “a seed campaign” because it is with reference to the seed campaign that a recommendation is desired. Specifically, the advertiser may ask for recommendations of product(s) for a particular ad campaign prior to booking the ad campaign (and agreeing on a price for the ad campaign). Thus, this ad campaign may be a proposed ad campaign that the online publisher has not previously booked. The ad campaign may therefore be identified by ad campaign information that the advertiser has provided. The ad campaign information may include a set of words. Since the ad campaign has not been booked, the information for the ad campaign may not identify information for one or more products and/or a number of impressions. Alternatively, the ad campaign may be one of the ad campaigns previously booked by the online publisher. In other words, the system may analyze the effectiveness of an ad campaign that has already been executed by comparing the ad campaign with neighbor campaigns that have been executed.

The system may process ad campaign information associated with ad campaigns previously booked by an online publisher to identify one or more of the ad campaigns that are similar (or statistical neighbors) to the ad campaign, at block 604. The ad campaign information for each of the ad campaigns may identify one or more products of the online publisher, as described above with reference to FIG. 3. In one embodiment, the system may process the ad campaign information by applying natural language processing (NLP), such as PLSI, to at least a portion of the ad campaign information associated with ad campaigns previously booked by the online publisher. The system may also process the ad campaign information for the ad campaign of the advertiser. Specifically, the system may compare at least a portion of the ad campaign information associated with the ad campaigns with at least a portion of ad campaign information associated with the ad campaign. This may be accomplished via a variety of algorithms, as will be described in further detail below.

The system may ascertain from the one or more ad campaigns previously booked by the online publisher that are neighbors to the ad campaign at least one of the products of the online publisher to recommend to the advertiser, at block 606. As described above, these products may be recommended in association with a proposed campaign, as well as in response to an ad campaign that has already been run. The ad campaigns that have been booked may be associated with a plurality of advertisers. The plurality of advertisers for which the ad campaigns have already been booked may or may not include the advertiser for which the recommendations are being provided or the analysis is being performed.

The system may analyze results of publishing advertisements for the campaigns previously booked by the online publisher that are similar to the ad campaign in order to identify the product(s) of the online publisher to recommend to the advertiser. This analysis may include filtering out campaigns that are lowest performing (e.g., highest cost to the advertiser and/or yielding the lowest profits or revenues for the advertiser) based upon the results of the campaign, such as those described above with reference to FIG. 3. For instance, the system may select a subset of the ad campaigns previously booked by the online publisher that are similar to the ad campaign (e.g., according to cost or performance of the similar (or neighbor) ad campaigns), and identify one or more products associated with the selected subset of the one or more ad campaigns. This enables the system to identify and recommend products that can provide an optimum result to the advertiser (e.g., low cost per click and/or low cost per conversion).

The product(s) that are recommended to the advertiser may be product(s) that have been implemented in the similar (or neighbor) ad campaigns. Those products that are recommended, however, need not be the same products that have been used in the neighbor ad campaigns. Rather, various components of products implemented in the selected subset of neighbor ad campaigns (e.g., the more effective products) may be identified in order to recommend one or more products using at least a portion of these various components such as FV pairs. These components may be identified by booking information such as that disclosed herein. For instance, components may include web page, position, target profile, etc.

Of course, rather than identify specific products to be recommended to the advertiser, the system 100 may provide information that indicates the effectiveness of an ad campaign that has already been run (e.g., executed or published) in comparison to other neighbor ad campaigns. This information may further identify product(s) associated with other, more effective neighbor ad campaigns. Thus, the system may consider the result of the identified ad campaign of the advertiser (e.g., by comparing the result with the neighbor ad campaigns). In this manner, the system may monitor the performance of the various campaigns that the online publisher has booked. Accordingly, the ad campaign information may be continually adjusted and refined when additional campaigns are booked and run.

Information indicating effectiveness of an ad campaign, product feature(s) and/or recommended products may be provided to an advertiser via a variety of mediums. Specifically, the information may be printed, displayed and/or transmitted via the network 110. For instance, the information may be transmitted via electronic mail.

FIG. 7 is a flow diagram of a method for processing ad campaign information as shown at block 604 of FIG. 6. In one embodiment, before processing the ad campaign information, a format of the ad campaign information associated with the ad campaigns (and/or the ad campaign of the advertiser) may be modified to generate modified ad campaign information, at block 702, which can be processed by a natural language processing (NLP) or other document clustering algorithm. For instance, where the ad campaign information for the ad campaigns is represented in a table or other format, it may be desirable to parse the ad campaign information and convert the parsed ad campaign information to another format. The resulting modified ad campaign information for each of the ad campaigns may include a set of words. This set of words may be referred to as a “bag of words” representation. This may be accomplished by “translating” at least a portion of the ad campaign information (e.g., numerical values, numerical ranges, and/or acronyms, etc.) in the ad campaign information to one or more words. For example, the age range “18-25” may be translated to “young.” Moreover, some of the ad campaign information may be eliminated or left untranslated during the generation of the modified ad campaign information. For instance, some fields of the ad campaign information may already be in text format. Thus, some words may not be translated and be left unchanged.

The resulting modified campaign information may consist of words (e.g., excluding numerical values), which may exclude acronyms or other “text” that may be difficult for a NLP (or document clustering) algorithm to interpret. In one embodiment, the modified ad campaign information for one of the ad campaigns previously booked by the online publisher may be represented by a single line of a document (e.g., a file). The NLP algorithm may therefore be performed on the modified campaign information of the ad campaigns previously booked by the online publisher and/or on the modified campaign information of the ad campaign of the advertiser (e.g., by performing NLP on the document).

Before performing NLP on the modified campaign information, the system may assign weights, at block 704, to one or more of the set of words in the modified ad campaign information for the ad campaigns (and/or the ad campaign of the advertiser) such that the modified ad campaign information includes the assigned weights. More specifically, because the set of words for a single ad campaign may include a small number of words, it may be desirable to assign a weight to one or more of the set of words for a campaign to give those words greater (or less) weight during the analysis of the set of words. These weights may be determined based upon a variety of factors, including the number of times a word is used in the set of words for the campaign or the number of times the word is used over all of the campaigns (e.g., in the document). As one example, for words that appear frequently (e.g., in campaign information for a large number of campaigns) or that do not help to characterize the campaigns, the weight of the words may be reduced. For instance, if a word occurs in the ad campaign information of all ad campaigns, it may be assigned a weight of zero. As another example, the weight associated with behavioral targeting words (e.g., categories) may be increased. Weights may be normalized for a campaign or advertiser to eliminate bias to higher spending campaigns or advertisers. A weighted set of words associated with an ad campaign may be referred to as a word vector.

In one embodiment, a base weight for a word may be the sum of revenues of all of the campaigns (e.g., lines) for which the word appears in the corresponding campaign information. For instance, if the word “finance” appears in two campaigns (e.g., two corresponding lines), with revenue $100,000 and $40,000, respectively, the word will be assigned a weight of $140,000. The “base weight” for a word may be increased or reduced based upon various factors such as those described above.

The system 100 may apply NLP to the ad campaign information and to the modified campaign information associated with the ad campaigns and the ad campaign of the advertiser, respectively, using a variety of mechanisms or algorithms. The term natural language processing (NLP) may generally refer to a range of computational techniques for analyzing and/or representing text. Probabilistic latent semantic indexing (PLSI) is one of many computational techniques that may be used to perform NLP. PLSI is also known as probabilistic latent semantic analysis (PLSA). PLSI may be applied to the modified campaign information of the ad campaigns (and modified ad campaign information for the ad campaign of the advertiser) to ascertain a distance (e.g., divergence) of other ad campaigns from the ad campaign of the advertiser (or seed campaign).

In one embodiment, at block 706, the system 100 applies PLSI to at least a portion of the ad campaign information as discussed above. This may be accomplished by applying PLSI to a document or file, and storing the modified ad information for the ad campaigns and the modified information for the seed campaign. Specifically, the PLSI algorithm may be applied to the weighted set of words (e.g., word vectors) for all of the ad campaigns that have been booked (and the identified seed campaign) in order to build a topic model. Using the topic model, the system may then derive a topical distribution for each of the ad campaigns (e.g., the seed ad campaign and the previously booked ad campaigns) in order to ascertain (e.g., measure) the distance between the seed campaign and each of the previously-booked campaigns. The distance between two campaigns may be measured using a Kullback-Leibler (KL) divergence between the two corresponding topical distributions.

A hybrid algorithm may also be employed to find the nearest or most related campaign IOs. The hybrid algorithm may combine PLSI with an advertiser category to identify neighbors, e.g., select neighbors that have the same advertiser category and that are otherwise similar as a result of application of PLSI.

The system may perform nearest neighbor searching to identify one or more of the previously-booked ad campaigns that are similar to the seed ad campaign, at block 708. Specifically, the system may identify a pre-defined number of “nearest neighbors” by identifying those ad campaigns that are closest in distance to the seed campaign of the advertiser based on the distances calculated at step 706. If each advertiser has a single ad campaign associated therewith, the disclosed embodiments may be used to compare the effectiveness of ad campaigns of the various advertisers. However, an advertiser may also simultaneously run multiple ad campaigns.

Although the disclosed embodiments assume that ad campaign information for campaigns of a plurality of advertisers is analyzed, these examples are merely illustrative. Thus, it may also be desirable to analyze ad campaigns associated with a single advertiser. Moreover, where ad campaigns identify multiple products, it may be desirable to apply NLP at the product or advertisement level, rather than at the campaign level. For instance, each line of a document may identify a different product that has been booked in association with an advertisement for an ad campaign.

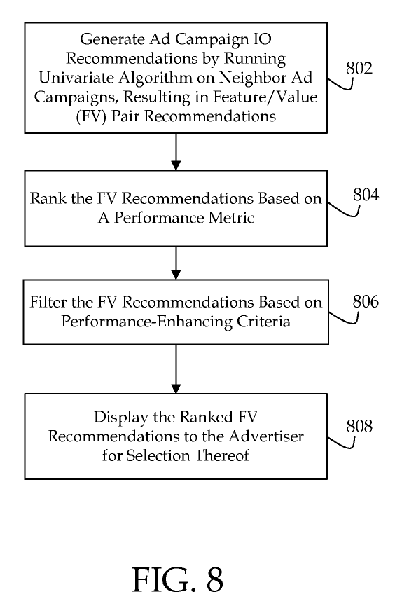

FIG. 8 is a flow diagram of a method for generating feature/value (FV) insertion order (IO) recommendations for an ad campaign. This approach is designed to make univariate FV recommendations for currently running IOs. These recommendations are of the form Feature=Value, examples of which were discussed with reference to FIG. 3. The recommendation engine 430 and/or processor 408, at block 802, generates ad campaign IO recommendations by executing a univariate algorithm to recommend campaign FV change(s) to a line of the seed campaign based on success of such use by the neighbor ad campaigns.

The algorithm identifies, for each seed IO, FV pairs whose presence in the lines of the seed IO and its neighbor IOs increases a performance metric, such as CTR, on average when compared to the lines of the seed IO and the neighbor IOs that do not have this FV combination. The algorithm takes as input a single IO and a set of neighbor IOs determined by the PLSI algorithm (described above) or other document clustering technique. The algorithm can rely on neighbor advertiser campaigns at either the IO level or at the advertiser level; for the latter, the algorithm considers all the IOs of neighbor advertisers in making recommendations.

The recommendation engine, at block 804, ranks the FV recommendations based on a performance metric, such as CTR, CPC, or lift. The recommendation engine, at block 806, filters the FV recommendations based on a plurality of performance-enhancing criteria of the seed campaign IO and the neighbor ad campaigns with respect to each potential FV recommendation. The recommendation server 130, at block 808, displays the ranked FV recommendations to the advertiser for selection. The performance metric may include conversion rate, CTR, CPC, cost per acquisition (CPA), return on investment (ROI), or a combination thereof, and therefore, reference to CTR and/or CPC herein is merely exemplary and to simplify discussion and nomenclature within algorithmic language. As discussed before, the recommendation engine 430 may also predict a value of a performance metric of the seed campaign IO based on adoption of one or more of the filtered recommendations, so the advertiser can make a more informed decision regarding selection thereof.

When displaying the ranked FV recommendations, certain information may be provided to the advertiser with which the advertiser may make an informed decision about whether to adopt the recommendation(s). The product recommendations may be identified in rows with information along the columns of such a display. For instance, the information along the columns may include, but not be limited to: (1) product being recommended by name; (2) whether or not the FV has been previously purchased; (3) neighbor (or similar) campaigns, including (a) use frequency; and (b) performance, to provide a sense of how much data was available from which to make the recommendation; (4) line details, such as the specific features and values; (5) position recommended for being displayed on landing page; and for each position, the (6) floor, or minimum possible, cost for implementation; (7) target cost for implementation; (8) the available number of impressions; and the (8) potential revenue achievable from implementing the recommendation.

Many different criteria may be used to filter the FV recommendations at block 806. The following is a non-exhaustive list and summary of exemplary criteria, which may be used for heuristic filtering of the FV recommendations. For instance, the filtering criteria may include a criterion that the recommended change to a line of the seed campaign IO has not been run by the advertiser before or that the recommended change creates a line that has been run more than a threshold number of times within the neighbor ad campaigns. The threshold number of times could be based on a minimum number of impressions obtained from click-related data of lines from the neighbor campaign lines. The filtering criteria may also include a criterion that the recommended change to the line of the seed campaign IO creates a line which, within the neighbor ad campaigns, has outperformed other ad campaigns as measured by a performance metric as listed above.

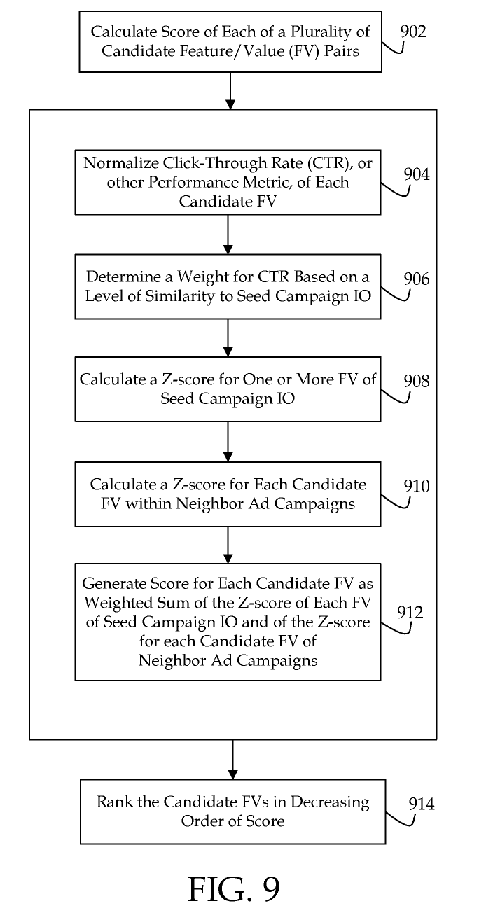

Furthermore, other criteria may include, but is not limited to, that: (A) lines with a CTR of more than 8%—a high CTR—may be excluded from computations as they may be considered noisy outliers; (B) the recommended FVs may not already occur in more than 75% of the lines of the seed campaign IO; (C) at least 2.5% of total weighted actual impressions in the neighborhood ad campaigns should have used the FV, wherein the weighting is discussed with reference to FIG. 9; (D) the presence of the FV should not correlate with low average CTR in lines—within the seed campaign IO or among neighbor IOs—that have the FV when compared with those IO lines that do not have the FV; and (E) the recommended FVs should not yield a NULL result, e.g., a recommendation to turn off a feature or targeting methodology may not be allowed.

FIG. 9 is a flow diagram of a method for calculating a score for each of a plurality of candidate FV pairs of FIG. 8, and ranking the scores in decreasing order of score. One way to generate the FV pair recommendations as disclosed with reference to FIG. 8 is to, at block 902, calculate a score for each candidate FV, which score denotes a lift in CTR or other performance metric. The candidate FVs may include combinations of feature/value pairs occurring in the seed campaign and in the neighbor ad campaigns. The recommendation engine 430 and/or processor 408 may calculate the score according to the following list of non-exhaustive steps of the method.

At block 904, the method normalizes the CTR—or other performance metric—for each candidate FV being recommended. At block 906, the method determines a weight for the CTR of each candidate FV score based on a level of similarity to the seed campaign IO as calculated by the statistical document clustering or NLP technique. At block 908, the method calculates a Z-score for one or more FV of the seed campaign IO, wherein the Z-score includes a statistical measure of change in the normalized CTR due to the presence of an FV in a line of an IO campaign. At block 910, the method calculates a Z-score for each candidate FV within the neighbor ad campaigns. At block 912, the method generates the score for each candidate FV as a weighted sum of the Z-score of each FV of the seed campaign IO and of the Z-score for each candidate FV within the neighbor ad campaigns.

Now, having obtained scores for the candidate FV recommendation pairs, at block 914, the method may rank the candidate FVs in decreasing order of their scores. Accordingly, the candidate FV's have been generated and ranked and are ready for filtering at block 806 of FIG. 8, as discussed above. Of course, the order by which the method filters and ranks the FV recommendations can be reversed in alternative embodiments without affect to the spirit and scope of this disclosure.

The following discussion explains in more detail the univariate algorithm broadly disclosed with reference to FIGS. 8 and 9. A few definitions (or assignments) will facilitate understanding the computations disclosed hereafter:

Variables: i denotes an IO (or advertiser, if advertiser-based recommendations are used); n denotes a neighbor IO of i generated by PLSI or other document clustering algorithm; l denotes a line; and v denotes a FV.

Functions and Sets: CTR(l) denotes the CTR of line l; Neighbor(i) is the set of all neighbor IOs of i generated by PLSI or other document clustering or NLP algorithm; R(i, n) returns an integer denoting the rank of neighbor n in the neighbors list of i; Lᵢ is a set of all lines in i; L_{v,i} is a set of all lines in i that have FV v; L_{i,n} is a set of all lines in neighbor IO n of IO i. L_{v,i,n} is a set of all lines in neighbor IO n that have FV v.

Derived Quantities: (a) C(v, i, l): a normalized CTR of line l containing FV v and belonging to IO i; (b) w_{i,n}: a weight assigned to lines belonging to neighbor n of IO i, currently derived from R(i, n); (c) Z(self v, i): a self Z-score, which is a statistical measure of change in CTR—or other performance metric—due to the presence of v in lines of i; (d) Similarly, Z(neighbors, v, i): a neighbor Z-score, is a statistical measure of change in CTR—or other performance metric—due to the presence of v in the neighbors n of i; (e) S(v, i) is a weighted linear sum of Z(self v, i) and Z(neighbors, v, i); (f) WI(v, i) is the weighted fraction of actual impressions in the neighbor lines of i with v.

Determination of CTR performance lift (or just “lift”) due to a FV involves at least two steps: (1) CTR normalization; and (ii) Z-score computation. CTR normalization is first discussed. To normalize CTR, for a given FV v, IO i, and line l, the following equations or expressions are defined as:

$$C ( v , i , l ) = \frac{C T R ( l )}{ω \cdot mean ( C T R ( i ) ) + ( 1 - ω ) \cdot mean ( C T R ( v ) )} \\ mean ( C T R ( i ) ) = \frac{{\sum }_{l ∈ IOi} ACTCLICK ( l )}{{\sum }_{l ∈ IOi} ACTIMP ( l )} \\ mean ( C T R ( v ) ) = \frac{{\sum }_{l ∈ IOi , l\_ contains \_ v} ACTCLICK ( l )}{{\sum }_{l ∈ IOi , l\_ contains \_v} ACTIMP ( l )} \qquad ( 1 )$$

where CTR(l) is the CTR of line l (in IO i) containing FV v, mean(CTR(i)) is the average CTR of all lines in IO i, and mean(CTR(v)) is the average CTR of all lines in the dataset containing FV v. Parameter value ω=0.5 is determined heuristically. ACTCLICK are the actual clicks of the line l in the IO i, and ACTIMP are the actual impressions of the line l in IO i.

For computing normalized CTR for lines that do not match a given feature, the denominator changes some, yielding the following corresponding sets of equations or expressions:

$$D ( v , i , l ) = \frac{C T R ( l )}{ω \cdot mean ( C T R ( i ) ) + ( 1 - ω ) \cdot mean ( C T R ( v ) )} \\ mean ( C T R ( i ) ) = \frac{{\sum }_{l ∈ IOi} ACTCLICK ( l )}{{\sum }_{l ∈ IOi} ACTIMP ( l )} \\ mean ( C T R ( v ) ) = \frac{TOTCLICK - {\sum }_{l ∈ IOi , l\_ contain s \_ v} ACTCLICK ( l )}{TOTIMP - {\sum }_{l ∈ IOi , l\_ contain s \_ v} ACTIMP ( l )} \qquad ( 2 )$$

where CTR(l)is the CTR of line l (in IO i) containing FV v, mean(CTR(i)) is the average CTR of all lines in IO i, and mean(CTR(v)) is the average CTR of all lines in the dataset that do not contain FV v. Parameter value ω=0.5 is determined heuristically. The term TOTCLICK is the total number of clicks over the lines in the IO i and TOTIMP is the total number of impressions over the lines in the IO i. The mean(CTR(v) equation is thus computed by calculating the total number of clicks and impressions in the database and subtracting from those numbers the total number of clicks and impressions over lines that contain feature v.

In order to perform the Z-score computation, weights must also be applied as follows. The PLSI (or other NLP) algorithm supplies a list of neighbor IOs of a given IO i in decreasing order of their similarity to i. For neighbor PLSI n of i rank, R(i, n) is the rank of n in the PLSI list. The weight given to CTRs of lines of the neighbor n is w_{i,n}=1/R(i,n). However, if the CATEGORY field of i and n are the same, the weight given to lines of those neighbors is denoted by w_{i,n}=η/R(i,n). Parameter η=2 is set heuristically. This essentially bumps up the ranking of same-category neighbors by a factor of two. Weights larger than 1 are clamped to 1. The first PLSI neighbor that is not the same as the IO itself gets weights ω_{i,1}=1. Different or additional weights may be defined for use.

Note that weights are calculated for only neighbors that have at least one matching line, or for non-matching lines for the non-matching weighted calculations. So, for example, if the seed campaign IO i has neighbors n1, n2, n3, n4 with 1,0,3,4 lines with the matching Feature-Value respectively, and where category of n4 is the same as the IO, the weights for these neighbors (and therefore for the matching lines of corresponding neighbors) will be, in order of IO, Neighbor, Weight: (1) i, n1, 1; (2) i, n2, 0; (3) i, n3, 0.5; and (4) i, n4, 0.66. The weight 0.66 above is because the weight of n4 would have been 0.33, but due to being of the same category, it was bumped up by twice. Same is true of weights for IOs while computing CTR of non-matching lines: only neighbor IOs with at least one line not matching the FV are assigned a weight.

The following includes a discussion of the details of the CTR Z-score computation. The final FV recommendation may be a weighted sum of the self Z-score and the neighbor Z-score.

Self Z-score Z(v, i) for a given FV v and IO i is computed using the set of lines Lᵢ in IO i. L_{v,i}⊂Lᵢ is the set of lines containing v. Now, let

$$\begin{matrix}{M}_{v , i} = \vert {L}_{v , i} \vert \\ {N}_{v , i} = \vert {L}_{i} \backslash {L}_{v , i} \vert \\ {m}_{v , i} = \frac{1}{{M}_{v , i}} {\sum }_{l ∈ {L}_{v , i}} C ( v , i , l ) \\ {n}_{v , i} = \frac{1}{{N}_{v , i}} {\sum }_{( {L}_{i} \backslash {L}_{v , i} )} D ( v , i , l ) \\ {p}_{v , i} = \frac{1}{{M}_{v , i} - 1 } {\sum }_{l ∈ {L}_{v , i}} {( C ( v , i , l ) - {m}_{v , i} )}^{2} \\ {q}_{v , i} = \frac{1}{{N}_{v , i} - 1} {\sum }_{( {L}_{i} \backslash {L}_{v , i} )} {( D ( v , i , l ) - {n}_{v , i} )}^{2}\end{matrix} \qquad ( 3 )$$

Means m_{v,i} and n_{v,i} are mean CTRs of lines in i that contain and don't contain the FV v, respectively. Variances p_{v,i} and q_{v,i} are the variances of the CTR of lines in i that contain and do not contain the FV v, respectively. Self Z-score is now computed as:

$$Z ( self , v , i ) = \frac{{m}_{v , i} - {n}_{v , i}}{sqrt ( {p}_{v , i} + {q}_{v , i} )} . \qquad ( 4 )$$

In the above Equations (3), p_{v,i}=0 if M_{v,i}<2 and q_{v,i}=0 if N_{v,i}<2. The Z-score above is valid only when denominator sqrt(p_{v,i}+q_{v,i})>0. Otherwise, Z(self v, i)=0. Additionally, if either M_{v,i}=0 or N_{v,i}=0, Z(self v, i)=0.

Neighbor Z-score, Z(neighbors, v, i), for a given FV v and IO i is computed similarly, but using the set of lines L_{i,n} in neighbors n of IO i. L_{v,i,n}⊂L_{i,n} is the set of lines of neighbor n containing v, for which

$$\begin{matrix}{M}_{v , i} = {\sum }_{n ∈ Neighbors ( i )} {w}_{i , n} \vert {L}_{v , i , n} \vert \\ {N}_{v , i} = {\sum }_{n ∈ Neighbors ( i )} {w}_{i , n} \vert {L}_{i , n} \backslash {L}_{v , i , n} \vert \\ {m}_{v , i} = \frac{1}{{M}_{v , i}} {\sum }_{n ∈ Neighbors ( i ) , l ∈ {L}_{v , i , n}} {w}_{i , n} C ( v , n , l ) \\ {n}_{v , i} = \frac{1}{{N}_{v , i}} {\sum }_{n ∈ Neighbors ( i ) , l ∈ ( {L}_{i , n} \backslash {L}_{v , i , n} )} {w}_{i , n} D ( v , n , l ) \\ {p}_{v , i} = \frac{1}{{M}_{v , i} - 1 } {\sum }_{n ∈ Neighbors ( i ) , l ∈ {L}_{v , i , n}} {{w}_{i , n} ( C ( v , n , l ) - {m}_{v , i} )}^{2} \\ {q}_{v , i} = \frac{1}{{N}_{v , i} - 1} {\sum }_{n ∈ Neighbors ( i ) , l ∈ ( {L}_{i , n} \backslash {L}_{v , i , n} )} {{w}_{i , n} ( D ( v , n , l ) - {n}_{v , i , n} )}^{2}\end{matrix} \qquad ( 5 )$$

where Neighbors(i) is the set of all PLSI neighbors of i. Weights w_{i,n} are explained in a previous subsection. Means m_{v,i} and n_{v,i} are weighted mean CTRs of lines in neighbors n∈Neighbors(i) that contain and don't contain the FV v, respectively. Similarly, variances p_{v,i} and q_{v,i} are weighted estimates of sample variances.

In the above Equations (5), M_{v,i} and N_{v,i} can be less than 1, resulting in a negative variance. However, if M_{v,i}<2, then p_{v,i} is set to zero and if N_{v,i}<2, then q_{v,i} is set to zero.

The Z-score is now computed as

$$Z ( neighbors , v , i ) = \frac{{m}_{v , i} - {n}_{v , i}}{sqrt ( {p}_{v , i} + {q}_{v , i} )} \qquad ( 6 )$$

Again, the Z-score in Equation (6) is valid only when the denominator sqrt(p_{v,i}+q_{v,i})>0. Otherwise, Z(neighbors, v, i)=0. A few variations of the above-special case have been experimented with, but performance did not change much in those cases. Additionally, if either M_{v,i}=0 or N_{v,i}=0, then Z(neighbors, v, i)=0.

For all FVs v in Lᵢ∪L_{i,n}, a final score, S(v, i), is generated. The final score S(v, i) for FV v and IO i is:

S(v,i)=α*Z(self,v,i)+(1−α)*Z(neighbors,v,i). (7)

The term α is empirically evaluated, and is currently set as 0.25, but this may be varied as necessary. Each FV v in i is assigned this score, S(v, i). FV selection and recommendation utilizes S(v, i), among other criteria as described above.

For FV v, a weighted fraction of impressions in the neighborhood of i is computed as

$$W I ( v , i ) = \frac{{\sum }_{l ∈ {L}_{v , i , n ∈ Neighbors ( i )}} {w}_{i , n} I M P ( l )}{{\sum }_{l ∈ {L}_{i , n ∈ Neighbors ( i )}} {w}_{i , n} I M P ( l )} \qquad ( 8 )$$

where Neighbors(i) are all PLSI (or other NLP) neighbors of IO i and IMP(l) is the total number of actual impressions in line l. WI(v,i) needs be above a tunable threshold for v to be selected.

Feature selection and output is disclosed as follows. Features are recommended for use for a given IO if the following conditions are met:

(1.) Do not select any features with value=NULL or CUSTOM1=0.

(2.) |L_{v,i}|/|Lᵢ|<β. Currently, β=0.75, and this prevents recommending FVs that are already heavily used in the IO. If β=0, then only FVs that are not previously used in the IO i are recommended.

(3.) S(v, i)>0 and Z(self v, i)>=0. Never recommend poorly performing FVs in the IO and do not recommend FVs that performed very poorly in the neighborhood. Since S(v, i) is a linear summation of self and neighborhood Z scores, the system may require that lines with v perform better than those without. These criteria, combined with the next condition, (4), allows for slight deterioration in CTR in the neighborhood in cases where the presence of FV v for the IO itself yields large CTR gains.

(4.) WI(v, i)>=γ. Currently, γ=0.025, but may be varied as deemed necessary. That is, at least 2.5% of the weighted actual impressions in the neighborhood must use the feature v if γ=0.025.

All FVs of i that satisfy the above conditions (1.)-(4.) are listed in descending order of S(v, i) as outputs. Click-through rate computations and other filter rules are now discussed in more detail. Various CTRs—or other performance metrics—are computed as follows. The various CTRs can be either an average of the CTR of each line, or a sum over all lines of the clicks divided by a sum over all lines of impressions.

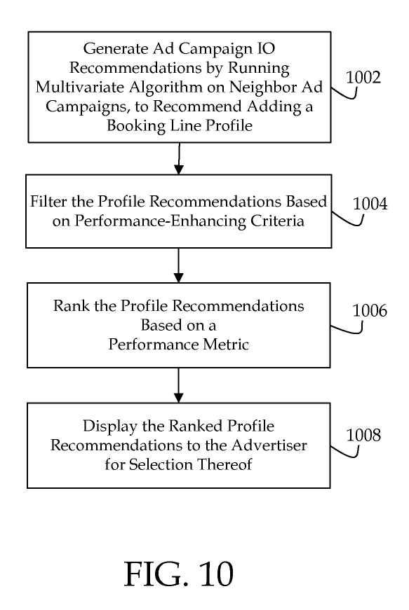

FIG. 10 is a flow diagram of a method for generating profile recommendations for a seed IO of an ad campaign. This approach is designed to make multivariate or full-line profile recommendations for currently running campaign IOs. These recommendations include an entire profile including placement and user targeting attributes in a form <Property, Position, BT, Geo, Demo>, examples of which were discussed with reference to FIG. 3. More or fewer than these features may be included. The recommendation engine 430 and/or processor 408, at block 1002, generates campaign IO recommendations by executing an algorithm to recommend profiles to add to the seed campaign IO, which are derived from booking lines corresponding to the profiles based on performance of such use by neighbor ad campaigns being generally above average when compared with campaigns that did not use the recommended profiles.

The recommendation engine 430, at block 1004, filters the profile recommendations based on a plurality of performance-enhancing criteria of the seed campaign IO and the neighbor ad campaigns with respect to each potential profile recommendation. The recommendation engine, at block 1006, ranks the profile recommendations based on at least one performance metric. Steps of blocks 1004 and 1006, of course, may be executed in reverse order in alternative embodiments. The recommendation server 130, at block 1008, displays the ranked profile recommendations to the advertiser for selection.

The at least one performance metric may include conversion rate, CTR, CPC, cost per acquisition (CPA), return on investment (ROI), or a combination thereof. As discussed before, the recommendation engine 430 may also predict CTR—or other performance metric—performance of the seed campaign IO based on adoption of one or more of the filtered recommendations, so the advertiser can make a more informed decision regarding selection thereof. Part of that performance forecasting may be performed through a probability mixture model (PMM) that combines the probability of a threshold CTR of the product (profile recommendation) in the neighborhood, in the current network, in the parent category, and/or in the entire network in a way that overlaps like overlapping Venn diagrams, for drawing logical relations between finite collections of sets of data.

When the recommendation server 130 displays the profile recommendations, it may do so in a graphical user interface (GUI) display including rows for each recommendation and information along the columns of the rows that advertisers may use to determine which recommendations to adopt. For instance, the information along the rows may include, but are not limited to: (1) property_position_path (PPP) values of the profile recommendation; (2) behavioral targeting (BT) sought; (3) whether the line has been previously purchased by the advertiser; (4) neighbor campaigns, including (a) use frequency; and (b) performance to provide a sense of how much data was available from which to make the recommendation; (5) position recommended for being displayed on landing page; and for each position, the (6) floor, or minimum possible, cost for implementation; (7) target cost for implementation; (8) the achievable number of impressions; and the (8) potential revenue available from implementing the recommendation. Of course, current campaign lines may be accessible through a different part of the GUI in order to compare current IO ad campaigns with those the system recommends. Also, the system may provide another part of the GUI for customization of an IO campaign line, revenue from which may also be predicted.

The details of the multivariate algorithm for generating the profile recommendations are as follows. Given an IO i, the algorithm finds the neighbor IOs (Nᵢ) identified by a document clustering technique such as the PLSI algorithm. For each neighbor n∈Nᵢ, the algorithms executes a) through c) below.

a) Let AVG_CTR(Nᵢ) be the average click-through rate (CTR) of the lines in N_{i.} and STD_CTR(Nᵢ) be the standard deviation of the click-through rate of the lines in Nᵢ. Note that CTR is used as an example here for simplicity of explanation, but that any performance metric may be used, including conversion rate, CPC, CPA, ROI, or a combination thereof.

b) Aggregate clicks and impressions and compute the average CTR for each distinct profile p that appears in the lines of Nᵢ−AVG_CTR_{Ni}(p).

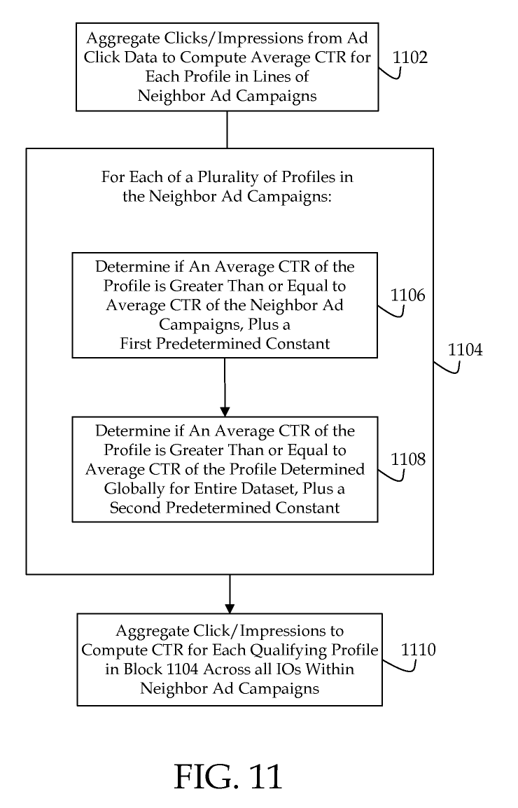

c) For every profile p identified above: (i) compute the global average CTR AVG_CTR_{DB}(p) and global average standard deviation STD_CTR_{DB}(p) of the profile p over the entire database (DB) of IOs as discussed in more detail with reference to FIG. 11 below; (ii) determine if AVG_CTR_{Ni}(p)≧AVG_CTR(Nᵢ)+δ₁*STD_CTR(Nᵢ); and (iii) determine if AVG_CTR_{Ni}(p)≧AVG_CTR_{DB}(p)+δ₂*STD_CTR_{DB}(p). Note that δ₁ and δ₂ are determined empirically from the data and are currently set to a value of 0.8, but could vary in range plus or minus 0.1 or more.

For every profile p that satisfies the performance criteria outlined in steps c(i) and c(ii) above: (1) remove profiles that have total impressions less than a preset number of impressions (MIN_IMPRESSIONS) where MIN_IMPRESSIONS is currently set to 10,000; and (2) remove profiles which have been used by fewer than a present number of advertisers (MIN_ADVERTISERS) where MIN_ADVERTISERS is currently set to 3. The set of profiles that satisfy the filtering criteria in (1) and (2) may be denoted as Q. The algorithm may then order the profiles in set Q in descending order of the designated performance metric (e.g., CTR, CPC, conversion rate, CPA, or ROI).

FIG. 11 is a flow diagram of a method for analyzing neighbor ad campaigns with performance criteria, to qualify potential profile recommendations from FIG. 10 for referral to an advertiser. Note that the neighbor ad campaigns may be derived from a dataset of all ad campaign IOs as stored in the data warehouse 140 or other database coupled with the recommendation server 130, such as recommendations database 134 and/or the campaign booking database 118.

The recommendation engine 130 and/or the processor 408, at block 1102, aggregates clicks and impressions from the advertisement user logs data to compute an average click-through-rate (CTR)—or other performance metric—for each profile that occurs in lines of the neighbor ad campaigns. The recommendation engine, at block 1104, determines an average CTR for each of a plurality of profiles in the neighbor ad campaigns by, at block 1106, determining if an average CTR of the profile is greater than or equal to an average CTR of the neighbor ad campaigns plus a first predetermined constant, and at block 1108, determines if an average CTR of the profile is greater than or equal to the average CTR of the profile determined globally for the entire dataset plus a second predetermined constant.

The first predetermined constant may be about 0.8 times the standard deviation of the CTR of all IOs within the neighbor ad campaigns, and the second predetermined constant may be about 0.8 times the standard deviation of the CTR of the dataset of ad campaign IOs. The recommendation engine, at block 1110, aggregates clicks and impressions to compute CTR—or other performance metric—of each qualifying profile in block 1104 (set Q) across all IO's within the neighbor ad campaigns.

To filter the profile recommendations as discussed in FIG. 10, the recommendation engine may, for every profile in set Q: (A) remove qualifying profiles that have total impressions less than a minimum threshold of impressions based on impressions obtained from the advertisement user logs data; and (B) remove qualifying profiles that have been used by less than a minimum number of advertisers within the dataset, also as determined from the advertisement user logs data. These may be referred to as popularity constraints.

The multivariate algorithm may employ sparse linear regression in order to incorporate consideration for each categorical variable, such as campaign ID, position, etc. The predictive model to date has used 19 variables, which are listed according to category in Table 1 below:

TABLE 1

| | | | | | |
|---|---|---|---|---|---|
| Category | Variable | Variable | Variable | Variable | Variable |

| | | |
|---|---|---|
| Advertiser | Advertiser ID | Full Advertiser |
| | | Category |
| Network | Property/Position | Property/Location |

| | | |
|---|---|---|
| Campaign | Order ID | |
| BT | Shopper | Engager |
| Demo- | Gender | Age Range |
| graphic | | |

| | | |
|---|---|---|
| Geographic | User Country Code | User DMA |

| | |
|---|---|
| Indicators | Age1; Gender1; Demo1; Geo1; Behavior1; |
| | Engager1; Shopping1 |

The system and methods disclosed herein may use more or less, or different, categories and variables as those listed in Table 1.

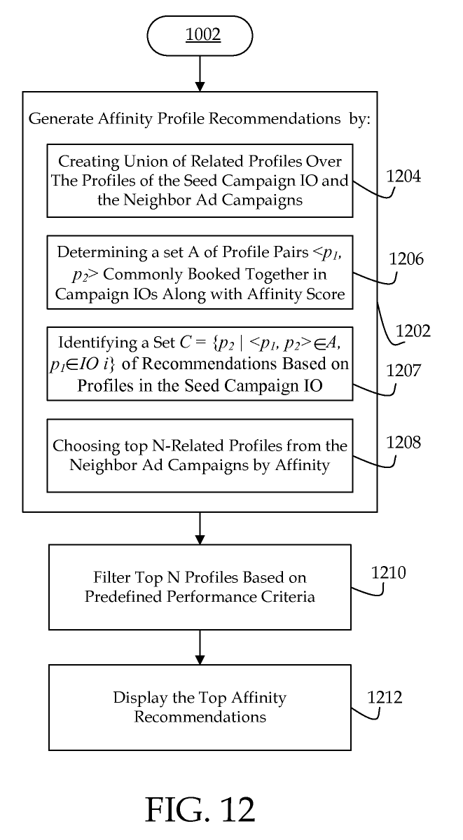

An alternative method for generating profile recommendations is by affinity-based analysis of the profiles of an ad campaign and neighbor ad campaigns. FIG. 12 is a flow diagram of a method for generating profile recommendations by this approach. This may be one of the possible multivariate algorithms disclosed above with reference to block 1002 of FIG. 10. The recommendation engine 430 and/or processor 408 may generate affinity profile recommendations at block 1202 by, at block 1204, creating a union of the related profiles over all the profiles of the seed campaign IO and the neighbor ad campaigns. Each campaign IO can be treated as a transaction and the profiles of each campaign IO as items of the transaction. At block 1206, the recommendation engine may determine a set A of pairs of profiles <p₁, p₂> from the union of campaign IO that are commonly booked together in the campaign IOs along with their affinity score. At block 1207, the recommendation engine may identify a set C equal to {p₂|<p₁, p₂>∈A, p₁ ∈IO i} of recommendations based on the profiles in the seed campaign IO i. At block 1208, the recommendation engine may choose the top N profiles from the candidate set C based on the affinity score. At block 1210, the recommendation engine 430 and/or processor 408 may further sort the filtered top N profiles by a performance metric, such as CTR or CPC, of each profile as determined globally in the set of all campaigns in the database. At block 1212, the recommendation engine may display the top affinity recommendations or otherwise output them for selection by an advertiser.

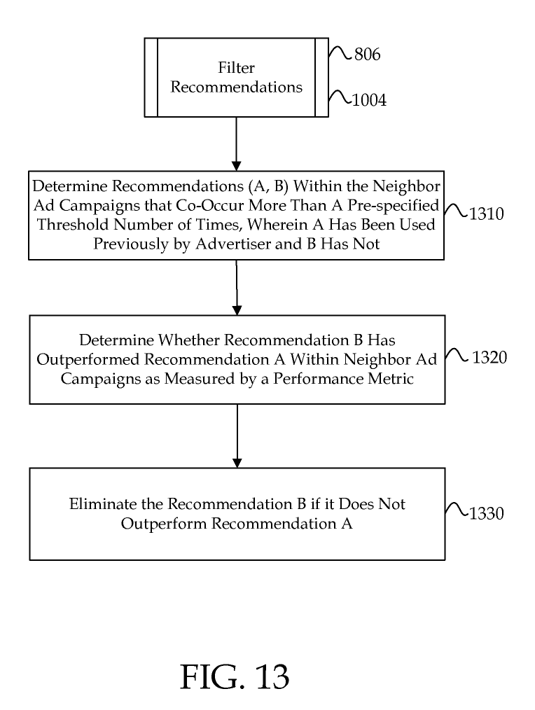

FIG. 13 is a flow diagram of a method for filtering recommendations generated using the affinity method before referral to an advertiser. These filtering steps stem from blocks 806 of FIG. 8 or 1004 of FIG. 10, as discussed above. The recommendation engine 430 and/or processor 408 may filter the profile recommendations by, at block 1310, determining recommendations (A, B) within the neighbor ad campaigns that co-occur therein more than a pre-specified threshold number of times, wherein recommendation A has been used previously in an ad campaign by the advertiser, and recommendation B has not been used previously in an ad campaign by the advertiser.

The recommendation engine, at block 1320, determines whether recommendation B has outperformed recommendation A within the neighbor ad campaigns according to a performance metric such as CTR or CPC. The recommendation engine, at block 1330, eliminates the profile recommendation B if it does not outperform profile recommendation A.

The system and process described may be encoded in a signal bearing medium, a computer-readable medium such as a memory, programmed within a device such as one or more integrated circuits, one or more processors or processed by a controller or a computer. If the methods are performed by software, the software may reside in a memory resident to or interfaced to a storage device, synchronizer, a communication interface, or non-volatile or volatile memory in communication with a transmitter. A circuit or electronic device may be designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “computer-readable storage medium,” “machine readable medium,” “propagated-signal medium,” and/or “signal-bearing medium” may include any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. An advertisement campaign performance improvement recommendation system comprising:
a server having a processor and system memory, wherein to improve performance of the seed campaign IO, the processor is configured to:
(a) receive a seed campaign insertion order (IO) that includes one or more campaign IO lines of an advertiser;
(b) compute a plurality of neighbor advertisement (ad) campaigns based on a comparison of the seed campaign IO with a dataset of advertiser ad campaigns IO lines by (i) processing campaign booking and performance information associated with ad campaigns previously booked by a publisher, and (ii) applying thereto a statistical document clustering technique;
(c) generate campaign IO recommendations by executing an algorithm to recommend a campaign feature and value (FV) as a change to a line of the seed campaign IO based on success of such use by the neighbor ad campaigns;
(d) rank the FV recommendations based on a performance metric;
(e) filter the FV recommendations based on a plurality of performance-enhancing criteria of the seed campaign IO and the neighbor ad campaigns with respect to individual FV recommendations; and
(f) display the ranked FV recommendations to the advertiser for selection.

2. The system of claim 1, further comprising:
a network interface configured to receive data feeds over a network, the data feeds including campaign IO lines and advertisement user log data associated therewith, wherein the network interface is coupled with the processor; and
at least one database, coupled with the processor, configured to store the campaign IO lines and the advertisement user log data, wherein the performance-enhancing criteria comprises a criterion that the recommended change to the line of the seed campaign IO creates a line that has been run more than a threshold number of times within the neighbor ad campaigns;
wherein the processor determines the threshold number of times based on a minimum number of impressions obtained from the advertisement user log data of lines from the neighbor ad campaigns.

3. The system of claim 1, wherein the performance-enhancing criteria comprises a criterion that the recommended change to the line of the seed campaign IO has not been run by the advertiser before.

4. The system of claim 1, wherein a lift in performance based on the change to the line of the seed campaign IO comprises at least one standard deviation higher than average when compared with other advertising lines within the neighbor ad campaigns.

5. The system of claim 1, wherein the performance metric comprises a conversion rate, click-through rate (CTR), cost per click (CPC), cost per acquisition (CPA), return on investment (ROI), or a combination thereof, wherein the processor predicts a value of a performance metric of the seed campaign IO based on the adoption of one or more of the filtered recommendations.

6. The system of claim 5, wherein the performance-enhancing criteria comprises a criterion that the recommended change to the line of the seed campaign IO creates a line which, within the neighbor ad campaigns, has outperformed other ad campaigns as measured by a performance metric.

7. The system of claim 5, wherein to generate the campaign IO recommendations, the processor:
calculates a score for each of a plurality of candidate FVs denoting a performance lift with regards to a performance metric, the candidate FVs including combinations of feature and value pairs occurring in the neighbor ad campaigns; and
ranks the candidate FVs in decreasing order of their respective scores.

8. The system of claim 7, wherein to calculate a score for each of the plurality of candidate FVs, the processor:
normalizes the performance metric for each candidate FV being recommended;
determines a weight for the performance metric of each candidate FV score based on a level of similarity to the seed campaign IO as calculated by the statistical document clustering technique;
calculates a Z-score for one or more FV of the seed campaign IO, wherein the Z-score comprises a statistical measure of change in the normalized performance metric due to the presence of an FV in a line of an IO campaign;
calculates a Z-score for each candidate FV within the neighbor ad campaigns; and
generates the score for each candidate FV as a weighted sum of the Z-score of each FV of the seed campaign IO and of the Z-score for each candidate FV within the neighbor ad campaigns.

9. The system of claim 5, wherein to filter the FV recommendations, the processor further:
determines FV recommendations (A, B) within the neighbor ad campaigns that co-occur therein more than a pre-specified threshold number of times, wherein recommendation FV A has been used previously in an ad campaign by the advertiser, and recommendation FV B has not been used previously in an ad campaign by the advertiser;
determines whether FV recommendation B has outperformed FV recommendation A within the neighbor ad campaigns according to a performance metric; and
eliminates the FV recommendation B if it does not outperform FV recommendation A.

10. A computer-implemented method for advertisement campaign performance improvement comprising:
(a) receiving, by a server from an advertiser, a seed campaign insertion order (IO) having one or more campaign IO lines;
(b) computing, by a processor coupled with the server, a plurality of neighbor advertisement (ad) campaigns based on comparison of the seed campaign IO with a dataset of advertiser ad campaign IO lines by (i) processing campaign booking and performance information associated with ad campaigns previously booked by a publisher, and (ii) applying thereto a statistical document clustering technique;
(c) generating, by the processor, campaign IO recommendations by executing an algorithm to recommend a campaign feature and value (FV) as a change to a line of the seed campaign IO based on success of such use by the neighbor ad campaigns;
(d) ranking, by the processor, the FV recommendations based on a performance metric;
(e) filtering, by the processor, the FV recommendations based on a plurality of performance-enhancing criteria of the seed campaign IO and the neighbor ad campaigns with respect to individual FV recommendations; and
(f) displaying, by the processor, the ranked FV recommendations to the advertiser for selection.

11. The method of claim 10, further comprising:
retrieving, by a network interface coupled with the server, data feeds including campaign IO lines and advertisement user log data associated therewith;
wherein the performance-enhancing criteria comprises a criterion that the recommended change to the line of the seed campaign IO creates a line that has been run more than a threshold number of times within the neighbor ad campaigns; and
determining, by the processor, the threshold number of times based on a minimum number of impressions obtained from the advertisement user log data of lines from the neighbor ad campaigns.

12. The method of claim 10, wherein a lift in performance based on the change to the line of the seed campaign IO comprises at least one standard deviation higher than average when compared with other advertising lines within the neighbor ad campaigns.

13. The method of claim 10, wherein the metric comprises a conversion rate, click-through-rate (CTR), cost per click (CPC), cost per acquisition (CPA), return on investment (ROI), or a combination thereof, the method further comprising:
predicting a value of a performance metric of the seed campaign IO based on the adoption of one or more of the filtered recommendations.

14. The method of claim 13, wherein the performance-enhancing criteria comprises a criterion that the recommended change to the line of the seed campaign IO has not been run by the advertiser before, or a criterion that the recommended change to the line of the seed campaign IO creates a line which, within the neighbor ad campaigns, has outperformed other ad campaigns as measured by a performance metric.

15. The method of claim 13, further comprising:
calculating, to generate the campaign IO recommendations, a score for each of a plurality of candidate FVs denoting a performance lift with regards to a performance metric, the candidate FVs including combinations of feature and value pairs occurring in the neighbor ad campaigns; and
ranking the candidate FVs in decreasing order of their respective scores.

16. The method of claim 15, wherein calculating the scores comprises:
normalizing the performance metric for each candidate FV being recommended;
determining a weight for the performance metric of each candidate FV score based on a level of similarity to the seed campaign IO as calculated by the statistical document clustering technique;
calculating a Z-score for one or more FV of the seed campaign IO, wherein the Z-score comprises a statistical measure of change in the normalized performance metric due to the presence of an FV in a line of an IO campaign;
calculating a Z-score for each candidate FV within the neighbor ad campaigns; and
generating the score for each candidate FV as a weighted sum of the Z-score of each FV of the seed campaign IO and of the Z-score for each candidate FV within the neighbor ad campaigns.

17. The method of claim 13, wherein filtering the FV recommendations further comprises:
determining FV recommendations (A, B) within the neighbor ad campaigns that co-occur therein more than a pre-specified threshold number of times, wherein recommendation FV A has been used previously in an ad campaign by the advertiser, and recommendation FV B has not been used previously in an ad campaign by the advertiser;
determining whether FV recommendation B has outperformed FV recommendation A within the neighbor ad campaigns according to a performance metric; and
eliminating the FV recommendation B if it does not outperform FV recommendation A.

18. A computer-readable storage medium comprising a set of instructions, the set of instructions to direct a processor to perform the acts of:
(a) receiving, by a server from an advertiser, a seed campaign insertion order (IO) having one or more campaign IO lines;
(b) computing, by a processor coupled with the server, a plurality of neighbor advertisement (ad) campaigns based on comparison of the seed campaign IO with a dataset of advertiser ad campaign IO lines by (i) processing campaign booking and performance information associated with ad campaigns previously booked by a publisher, and (ii) applying thereto a statistical document clustering technique;
(c) generating, by the processor, campaign IO recommendations by executing an algorithm to recommend a campaign feature and value (FV) as a change to a line of the seed campaign IO based on success of such use by the neighbor ad campaigns;
(d) ranking, by the processor, the FV recommendations based on a performance metric;
(e) filtering, by the processor, the FV recommendations based on a plurality of performance-enhancing criteria of the seed campaign IO and the neighbor ad campaigns with respect to individual FV recommendations; and
(f) displaying, by the processor, the ranked FV recommendations to the advertiser for selection.

19. The computer-readable storage medium of claim 18, further comprising a set of instructions to direct a processor to perform the acts of:
retrieving, by a network interface coupled with the server, data feeds including campaign IO lines and advertisement user log data associated therewith;
wherein the performance-enhancing criteria comprises a criterion that the recommended change to the line of the seed campaign IO creates a line that has been run more than a threshold number of times within the neighbor ad campaigns; and
determining, by the processor, the threshold number of times based on a minimum number of impressions obtained from the advertisement user log data of lines from the neighbor ad campaigns.

20. The computer-readable storage medium of claim 18, wherein a lift in performance based on the change to the line of the seed campaign IO comprises at least one standard deviation higher than average when compared with other advertising lines within the neighbor ad campaigns.

21. The computer-readable storage medium of claim 18, wherein the performance metric comprises a conversion rate, click-through-rate (CTR), cost per click (CPC), cost per acquisition (CPA), return on investment (ROI), or a combination thereof, further comprising a set of instructions to direct a processor to perform the acts of:
predicting a value of a performance metric of the seed campaign IO based on the adoption of one or more of the filtered recommendations.

22. The computer-readable storage medium of claim 21, wherein the performance-enhancing criteria comprises a criterion that the recommended change to the line of the seed campaign IO has not been run by the advertiser before, or a criterion that the recommended change to the line of the seed campaign IO creates a line which, within the neighbor ad campaigns, has outperformed other ad campaigns as measured by a performance metric.

23. The computer-readable storage medium of claim 21, further comprising a set of instructions to direct a processor to perform the acts of:
calculating, to generate the campaign IO recommendations, a score for each of a plurality of candidate FVs denoting a performance lift with regards to a performance metric, the candidate FVs including combinations of feature and value pairs occurring in the neighbor ad campaigns; and
ranking the candidate FVs in decreasing order of their respective scores.

24. The computer-readable storage medium of claim 23, further comprising a set of instructions to direct a processor to perform the acts of:
normalizing the performance metric for each candidate FV being recommended;
determining a weight for the performance metric of each candidate FV score based on a level of similarity to the seed campaign IO as calculated by the statistical document clustering technique;
calculating a Z-score for one or more FV of the seed campaign IO, wherein the Z-score comprises a statistical measure of change in the normalized performance metric due to the presence of an FV in a line of an IO campaign;
calculating a Z-score for each candidate FV within the neighbor ad campaigns; and
generating the score for each candidate FV as a weighted sum of the Z-score of each FV of the seed campaign IO and of the Z-score for each candidate FV within the neighbor ad campaigns.

25. The computer-readable storage medium of claim 24, further comprising a set of instructions to direct a processor to perform the acts of:
determining FV recommendations (A, B) within the neighbor ad campaigns that co-occur therein more than a pre-specified threshold number of times, wherein recommendation FV A has been used previously in an ad campaign by the advertiser, and recommendation FV B has not been used previously in an ad campaign by the advertiser;
determining whether FV recommendation B has outperformed FV recommendation A within the neighbor ad campaigns according to a performance metric; and
eliminating the FV recommendation B if it does not outperform FV recommendation A.
